(19) United States
(12) Patent Application Publication
(10) Pub. No.: US 2002/0067772 A1
(43) Pub. Date: Jun. 6, 2002

(54) Method and system for sending information over metal wire

(76) Inventors: Michael B. Shepperd, Livermore, CA (US); Allan L. Blevins, Napa, CA (US); Ivan Gerarde, Milpitas, CA (US)

Correspondence Address: Jurgen Vollrath, 1222 Settle Ave, San Jose, CA, 95125, US

(21) Appl. No.: 09/833,920

(22) Filed: Apr. 11, 2001

Related U.S. Application Data
(60) Provisional application No. 60/214,861, filed on Jun. 28, 2000.
(60) Provisional application No. 60/217,623, filed on Jul. 11, 2000.

(51) Int. Cl. H04L 27/20

(52) U.S. Cl. 375/308

(57) ABSTRACT

In a system and method of transmitting information over metal wire, a plurality of base band encoded frequencies are combined to create a single complex, modulated signal that will produce a desired throughput. The various digital signals are encoded using phase shifting to represent logic changes. At the receiver, the signals are separated and each signal is decoded by considering several sidebands for each baseband signal, covering 180° of phase. Synchronicity is ensured by transmitting a pilot frequency.

### BACKGROUND OF THE INVENTION

1. Field of the Invention

The invention involves the transmission of signals over metal wire. In particular, the invention deals with a method and system for facilitating a high rate of transfer of data over metallic wire.

2.Description of Prior Art

Modulation of an electrical or electronic signal whether or not it is being transmitted along a metallic wire or transmission media can be grouped into one of two distinct categories, namely base band modulation, and carrier modulation. Base band modulation transfers data at the transmission frequency, also referred to as the transmission speed, or greater, of the modulation, while carrier modulation uses a carrier signal that is transmitted at a certain frequency and has data impressed thereon using modulation techniques such as frequency modulation (FM) or amplitude modulation (AM), wherein the transfer rate of data is less than the frequency of the transmitted carrier signal.

One of the earliest known types of electrical communication is telegraphy. A simple telegraph system makes use of a sending device, a receiving device and two wires that carry a DC voltage. In this simplified implementation each end of the wire would be connected to a unit that is a combination of sender and receiver. The sender is typically built with a switching device called a key that, when momentarily connected across one end of the wire, will vary or modulate the DC voltage present. The modulation is the result of momentarily increasing or decreasing the voltage in such a way as to create a low frequency sinusoidal wave shape. A receiver connected to the wire detects this modulation as an audible click or, if the key was connected for a long enough time, a buzzing sound. Telegraph systems made use of this modulation by having an operator press the key of the sender for short prescribed periods of time. Specifically, Morse code was utilized to encode words in what is known as dots and dashes encoding. The receiver connected to this system would react to the key being pressed and create correspondingly short and slightly longer sounds. These sounds would then be decoded back into the words that were originally encoded.

Base band and carrier modulation techniques have transfer rate and distance limitations when used over metallic wire, with specific limitations dictated by the type of metallic wire, such as that making up a telephone cable. This is due to the electrical characteristics of the wire that was designed and manufactured to be the most efficient at frequencies under 10 kHz. Modulated signals transmitted at frequencies above 10 kHz encounter ever increasing distortion due to dispersion effects, and reduction in received signal amplitude, or attenuation, as the frequency rises and the length of the telephone cable increases.

Early systems for transmitting analog voice signals over wire used base band techniques and provided the basis for what we know as the telephone system. However, as the use of the telephone became ubiquitous in North America after WWII, these basic systems were not capable of keeping up with the ever increasing volume of telephone calls. By the early 1950's AT&T developed an analog transmission system based on carrier techniques. It was capable of carrying 13,200 analog telephone calls simultaneously, and was referred to as Analog Grouped Carrier System, whereby each telephone call was encoded within a unique carrier frequency, which each carried the same amount of data irrespective of the frequency of the carrier wave. The various frequencies were combined to create a single carrier which was used to transfer data between telephone company equipment. Numerous unique carrier signals that were a minimum of 4 Khz apart, and each contained an analog voice signal, were combined using analog up converters, mixers and down converters to create a single carrier that contained a large amount of analog information. This particular system was implemented for use only as a connection between telephone company equipment, and required repeaters and regenerators for cable lengths that exceeded 6000 feet. Such an arrangement is illustrated in FIG. 10 in which a plurality of voice signals 100 are amplified by means of amplifiers 102 and fed into respective mixers 104. Each mixer 104 is supplied with a separate carrier sine wave serving as carrier input 106, and each carrier wave is separated from the next by at least 4 kHz. The resultant signals 108 are fed into a summer 110. The combined signal is fed into an up-converter 112 which places the combined signal onto a carrier wave of 8.248 MHz. At the receiving end the signal is fed into a down-converter 114 that strips off the carrier wave. This technology thus provided a method that sought to maximize the amount of analog information that could be transmitted via telephone wire with its various limitations.

However, while this analog carrier technology provided a method to transmit a significant amount of analog information, it did not provide a means to encode and transmit digital data. Carrier based digital transmission systems prior to 1990 suffered from a combination of significant signal distortion, too small of a data rate and too short transmission distances. In contrast, base band modulation was found to be less adversely affected by the electrical characteristics of telephone cable. Base band signals can be transmitted at higher frequencies over great distances due to less complex encoding techniques that make the data more robust and thus more easily detected and decoded. Base band typically employs a technique that is similar in concept to the way data is encoded by a telegraph sender. Binary data, represented by either a “1” or a “0”, similar to the on or off of the telegraph key, is encoded in a stream of sinusoids that make up a base band signal. Technology enhancements have built on these basic concepts to further enhance the robustness of base band transmission systems, with a method referred to as Manchester coding being the most well known. As a result, base band modulation became the primary method for transmission of digital data over telephone wires at rates higher than 56 Kbs until the early 1990's.

Using base band techniques, AT&T developed the basic transmission technology for digital data on telephone wire in the early 1960's. The basis for this technology and the basis for almost all digital transmission systems used today is derived from the requirement to transmit analog voice information, as well as pure digital data obtained from computer systems. It was found that in order to accurately transmit and receive voice information via digital transmission methods, the voice signal had to be sampled every 125 μs,or at a sampling rate of 8 kHz. Each sample is typically represented by 8 digital bits, thereby providing 64,000 bits/s.

The requirement for including digitized voice within a digital transmission system gave rise to what is now referred to as a digital hierarchy. This hierarchy provides definitions for digital systems that contain ever increasing amounts of data. The smallest amount of data defined by this hierarchy is referred to as DS0. DS0 is defined as 64,000 bits/s (64 kbs). While the DS0 definition is based on the sample rate for digitizing voice, it also includes pure digital bits. Until the advent of fiber optic technology, the digital hierarchy consisted of base band transmission systems that ranged in speed from 1.544 Mbs to 274.176 Mbs, varying slightly for systems implemented outside North America.

The most commonly known part of this hierarchy is referred to as T1 or DS1, which transmits digital information at a rate of 1.544 Mbs. A single DS1 is comprised of slower rate data sources in the forme of DS0s, that are individually base band. Pluralities of DS0's are inserted in a serial manner as data into the stream of a single higher rate base band signal. The serial manner used to create the DS1 signal is referred to as Time Division Multiplexing (TDM). A TDM base band signal utilizes a frame structure that allocates each of the slower rate sources, in this case the DS0s, a fixed number of bits out of the higher rate base band signal. In the case of DS1, 24 DS0 sources comprise the total amount of digital data transmitted. This is illustrated in FIG. 11 wherein a frame is defined as one sample from each of 24 samplers 116 and a framing bit. Thus, at 8 bits/sample each frame comprises (24×8)+1=193 bits/frame. As shown in FIG. 11, each of the samplers comprise a D/A converter 116 with the frame 118 being created by samples taken from each of the 24 D/A converters. DS1 transmission systems can use standard telephone cables but require 4 wires and must have repeaters or regenerators installed at 6,000 feet intervals.

The next most widely used part of the digital hierarchy is referred to as T3 or DS3, which comprises 28 T1s to provide a data transmission rate of 44.736 MBS. This rate is used for high volume traffic connections and requires coaxial cable that is limited to 300 meters. The coaxial connection typically connects to a microwave or other type of radio frequency transmission system that is used to connect main stations of a telephone network such as San Jose Main Telephone Station with San Francisco Main Telephone. This is illustrated in FIG. 12 in which the individual users 120 are connected to central stations 122. The central stations 122 are, in turn, connected to a main station 124 by means of T1 connections 126. The main station 124 is, then, connected to another main station 128 by means of a T3 connection 129.

The digital hierarchy has been expanded since the early 1980's to include transmission rates made possible by the development of fiber optic technology. For example, OC1 transmits data at a rate of 51.844 MBS; OC3 transmits at 155 MBS; OC12 transmits at 622 MBS.

In the early 1990's, the Amati Corporation introduced a carrier based digital transmission method for use over copper wire that was faster than 1.544 MBS and did not require repeaters or regenerators. They enhanced the earlier Analog Grouped Carrier technology in which a number of unique carrier signals were used, each of which were 4 kHz apart, by utilizing, and enhancing, a method to encode digital data onto each of the unique carriers. The encoding methodology adopted is similar to quadrature amplitude modulation (QAM), and since other technologies have also adopted QAM, it is appropriate to consider this further.

QAM is a technique that was originally developed to increase data transfer rates for satellite transmission. The standard QAM technique uses a single sinusoidal frequency for a carrier. This carrier frequency has data encoded into it by modifying both the phase and amplitude of each cycle of the carrier signal thereby creating a symbol. A preestablished reference amplitude and phase value is used to compare each cycle of the received signal as a means to determine the numerical value of the encoded information. QAM encoded data is a non binary number such as a hexadecimal number that counts from “0” to “F”. All necessary information to decode a this non binary number is represented by the symbol contained within a single cycle of the carrier's sinusoidal signal.

The technology developed by Amati, which is referred to as Discreet Multitone Technology (DMT), was subsequently adopted by ANSI as the transmission technology for a currently known standard commonly referred to as ADSL. This technology provides a method of transmitting digital data in one direction at a higher rate of up to 8 MBS, and in the opposite direction at a lower rate of up to 1 MBS, using 2 wires. The implementation of DMT is more clearly illustrated in FIG. 13 in which a frequency band from 30 kHz−1.3 MHz is divided into 4 kHz channels 130 to provide 249 down stream channels and 25 upstream channels. One possible implementation of DMT has each cycle of each channel containing one of 15 symbols which, at 4 kHz constitutes: 249 channels×4,000 Hz×15 which equals a theoretical rate of 14.9 million symbols/sec.

However, due to the filter effect of metal transmission lines, mentioned above, although 249 channels could in theory be sent downstream, the metallic transmission medium limits the typical transmission rate to approximately 384 Kbs. DMT's inability to implement higher rates is due to the fact that QAM technology requires the received signal to have significant signal integrity. The combination of dispersion and the inherent low pass filter affects of wire cable make it very difficult to accurately receive and recover the phase and amplitude of each symbol encoded in each cycle of the carrier.

Since the introduction of DMT, another digital transmission technology has been developed, referred to as Single Carrier Modulation (SCM). This technology does not use multiple channels but does utilize a QAM like encoding method. SCM encodes digital data within a single carrier frequency whereby a symbol can represent a number that ranges from 0 to 255. This increase in the encoded symbol representation was necessary in order to attain the same digital transmission rates possible via DMT.

SCM technology is based on the assumption that a single carrier is more robust than the multiple carriers that comprise DMT, and was developed because DMT was not capable of accurately delivering digital data at rates above 1 Mbs over telephone cable for distances greater than 6,000 feet. While this assumption has proven to be valid, SCM has had other problems that have shown it to be no more robust than DMT. The significant increase in complexity of an encoded symbol that represents a number that ranges from 1 to 255 instead of a number that ranges from 1 to 15 has eliminated any advantage a single carrier has over multiple carriers. Typical SCM systems are therefore also typically limited to transmission rates of 384 Kbs.

Currently the developers of both SCM and DMT are attempting to significantly enhance both technologies in an attempt to provide a digital data transmission capability over standard metal telephone cables at rates of up to 52 Mbs for wire lengths longer than 4,500 feet. The proposed enhancements have not changed the fundamental basis for either technology, which has limited the ability of either technology from attaining these goals.

The present invention seeks to address current technology limitations whereby it will provide digital data transmission over standard telephone cables at higher data rates and longer distances. The present invention directly addresses the problems of using not only telephone cables, but also any type of metallic cable.

### SUMMARY OF THE INVENTION

The present invention provides a method of encoding and transmitting and receiving and decoding data in conditions where there is significant signal distortion and loss of signal amplitude due to the characteristics of metal wire.

The present invention proposes a method and system for transmitting information, whereby a group of unique frequencies, each of which contains digital information encoded via a base band process, is combined into a single complex, modulated signal, and transmitted over metallic wire.

According to the invention, there is provided a method of sending information over metal wire comprising combining a plurality of predefined frequencies, wherein each frequency is base band encoded with binary data to carry a different amount of information in a given period of time. Typically, a highest frequency is chosen by determining a practical maximum frequency for a desired distance, selecting a desired information throughput, and dividing the desired throughput by an integer divisor that will provide a highest frequency riot exceeding the maximum frequency. Subsequent lower frequencies may then be chosen by dividing the desired throughput by ever increasing higher integer or non-integer divisors or by subtracting a predetermined frequency value from each preceding frequency to arrive at the next lower frequency. Preferably, the base band encoded frequencies are combined by means of at least one summation amplifier. In order to decode each base band encoded frequency, the invention proposes analyzing the power inherent in each base band signal by analyzing a plurality of its sidebands, preferably including the sideband having half the frequency of the base band frequency being analyzed. The idebands considered that are considered, provide frequency variation information across 180° of the spectrum. In analyzing the sidebands, positive and negative excursions of the signal are considered. It has been found in one embodiment that a positive excursion exceeding a pre-determined positive threshold corresponds to a digital one, a negative excursion exceeding a predetermined negative threshold corresponds to a digital zero, and two opposite excursions within a 180° portion of the spectrum define a digital one if the negative excursion precedes the positive excursion and define a digital zero if the positive excursion precedes the negative excursion.

Further, according to the invention, there is provided a transmitter for sending information over metal wire comprising a multiple frequency clock source, a data encoder for creating a plurality of BPSK encoded data-carrying baseband signals, and a combiner for merging the signals, wherein the clock source produces a different frequency clock signal for each of a plurality of data-carrying base band signals and for a pilot signal. The transmitter typically includes a buffer capable of storing at least two frames of data, wherein a frame is an integer divisor of the highest frequency multiplied by the period of a cycle of said highest frequency.

Still further, according to the invention, there is provided a receiver for decoding a multiple frequency signal comprised of a plurality of predetermined data carrying frequencies that are each base band encoded using BPSK techniques, comprising a set of filters tuned to the frequencies of a plurality of sidebands for each of the data carrying frequencies, and means for analyzing the plurality of sidebands of each data carrying frequency to decode the data. The receiver typically includes a data buffer capable of storing at least two frames of incoming data, wherein a frame of incoming data is defined as an integer divisor of the highest frequency multiplied by the period of a cycle of said highest frequency.

The present invention's method of modulation can be referred to as Grouped Frequency Modulation (GFM). More particularly a GFM signal is created by determining a maximum frequency that is a divisor of a desired higher data transfer rate such as 52 MBS. This maximum frequency and a number of other frequencies, each of which is unique and is less than the maximum frequency are simultaneously produced, wherein the digital data is encoded into each of these multiple frequencies at the rate of or greater than each individual frequency. In other words, each individual frequency is base band modulated.

GFM is best explained by using a computer bus as an analogy. A computer bus provides an aggregate data transfer rate based on the data transfer rate of each connection that makes up the bus. GFM implements a similar concept by using simultaneous multiple frequencies as if they were a bus. GFM's data transfer rate is determined by the aggregate of the transfer rates of the individual different frequencies.

Preferably GFM utilizes a previously known method of digital base band encoding described as Bipolar Phase Shift Key or BPSK. BPSK encodes binary data, which is represented as a “1” or “0”, in each cycle of a frequency's sinusoidal wave shape. Specifically a binary “1” is encoded by using the default phase of a cycle and a binary “0” is encoded by reversing the phase. i.e. shifting the phase by 180 degrees.

The simplicity of base band encoding as compared to the complexity of a QAM like encoding technique, provides a much more robust received signal. Successful recovery of a cycle of BPSK encoded data relies simply on a 180 degree phase shift, rather than the complex combinations of amplitudes and ranges of phase shifts required for QAM.

These multiple base band encoded signals are then combined to create a single complex, modulated signal that is transmitted to a receiver in a manner such that each transmitted frequency forming part of the single complex signal transfers a certain number of data bits in a specified time period, referred to as a frame. The size of a frame will typically be a divisor of the selected maximum frequency. Thus the time length of the frame will be the size of the frame, in cycles, divided by the selected maximum frequency. The number of unique frequencies is chosen to produce a data transfer rate that is equal to or exceeds, the total number of bits required to support the desired higher rate of data transfer.

The present invention provides several advantages over previous known metallic wire transmission systems such as higher data rates and longer wire lengths. The transfer rate is dependent on the length and type of wire used. For example, the present invention provides for a data transfer rate of 1.2 Gbs for a distance of 3,000 feet over CAT5 or CAT3 cable and another example provides a data transfer rate of 52 Mbs for a distance of greater than 9,000 feet over standard 26 gauge telephone wire.

### BRIEF DESCRIPTION OF THE DRAWINGS

FIG. 1 represents a list of information about one embodiment regarding frequencies and the number of bits per frame and other information;

FIG. 2 is a representation of two sine waves for two frequencies in accordance with the invention;

FIG. 3 represents an embodiment of timing diagrams for a number of frequencies, their bits per frame and how the frequencies line up in a frame;

FIG. 4 represents an embodiment of a block diagram of a transmitter device;

FIG. 5 represents an embodiment of a block diagram of a transmitter's FPGA;

FIG. 6 is a schematic representation of a summation amplifier of the invention;

FIG. 7 represents an embodiment of a block diagram of a receiver device;

FIG. 8 represents an embodiment of a block diagram of a receiver's FPGA;

FIG. 9 shows four summed sidebands of one frequency in relation to that frequency's clock;

FIG. 10 shows a schematic representation of a prior art AGC device;

FIG. 11 is a representation of the creation of frames in a T1 system;

FIG. 12 is a representation of the use of a prior art T3 line, and

FIG. 13 illustrates the concept of DMT.

### DETAILED DESCRIPTION OF SOME EMBODIMENTS OF THE INVENTION

In a preferred embodiment of the present invention a desired data transfer rate between a transmitter and a receiver is established, whereafter a maximum frequency is selected which is an integer divisor of the required data transfer rate. For illustrative purposes, an embodiment is described for achieving a data transfer rate of 52 Mbs for a distance of 9,000 feet. In this embodiment a maximum frequency of 3.25 MHz is chosen for the following reasons:

The maximum frequency is a function of the physical characteristics of the metal wire and the desired distance over which the data is to be transmitted. Sinusoidal signals transmitted over telephone cable at frequencies above 3.5 MHz do not have enough signal integrity beyond 9,000 feet to allow implementation of the present embodiment using currently available hardware. 3.25 MHz is the first frequency less than 3.5 MHz that is an integer divisor of 52 million.

Also, the present embodiment must be implemented at a reasonable production cost. While a lower maximum frequency would provide a means to extend the data transfer rate of 52 Mbs to 18,000 feet, the lower maximum frequency would result in a significant increase in the cost to produce the present embodiment since more unique base band frequencies would be required. While the present embodiment has certain distance restrictions, it is adequate for reaching up to 50% of the customers that are connected to North American telephone systems.

As a further illustration of some of the concepts of the invention, another embodiment may be considered, requiring a 1 GHz transfer rate over CAT5 cable. Due to the lower dispersion and attenuation characteristics of CAT5, if 3,000 foot distance is desired, the highest frequency could be chosen at 100 MHz. Again, since the other base band frequencies will be lower, more than 10 frequencies are required to support the desired 1 GHz throughput. It has been found that a good first estimate is to add 20% more frequencies in order to approximate the required number of frequencies: in this example, 10+2=12 frequencies. The actual number can be arrived at using an iteration process, as is discussed further below, with respect to the 52 Mbs embodiment.

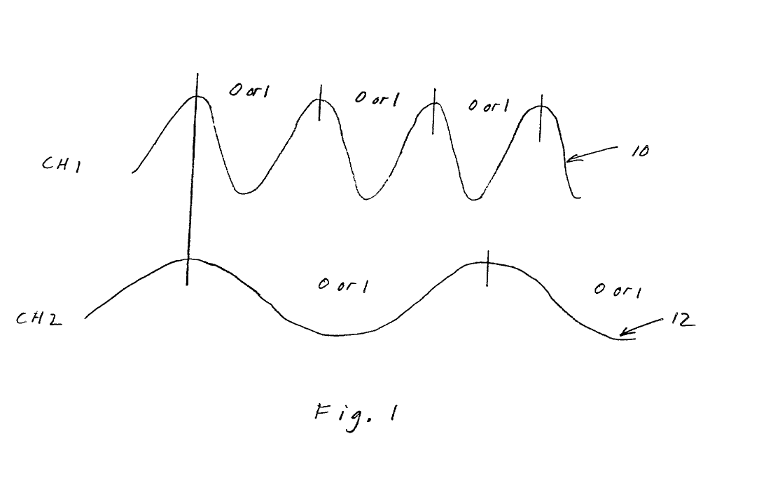

A representation of two frequencies in accordance with the invention is shown in FIG. 1 by means of two sine waves wherein each cycle represents either 0 or 1. Since base band modulation is used, the higher frequency 10 has a higher data transfer than frequency 12. The present invention also contemplates the option of transmitting more than one bit per cycle using different encoding technique such as QPSK. It will be appreciated that the use of other more complex encoding techniques will require consideration of the implementation requirements for distance and data transmission rates. For instance, the number of sidebands that have to be considered to decode the signal, will be effected.

In the present embodiment the various frequencies are derived from a single master clock which is running at 208 MHz. 208 MHz was chosen for this embodiment by multiplying the desired throughput of 52 Mbs by 4 in order to achieve a sufficiently high master clock frequency for deriving the various unique frequencies from a single clock source such as a crystal oscillator. The various frequencies are produced by dividing the master clock by 63+n where n=the frequency number which in this embodiment ranges from 1 to 19. The maximum frequency is designated as frequency 1, with each succeeding frequency designated as frequency (1+n). This would provide a set of frequencies as follows:

208 MHz/64=3.25 MHz,

208 MHz/65=3.20 MHz,

208 MHz/66=3.151515 . . . MHz, etcetera, for the other frequencies.

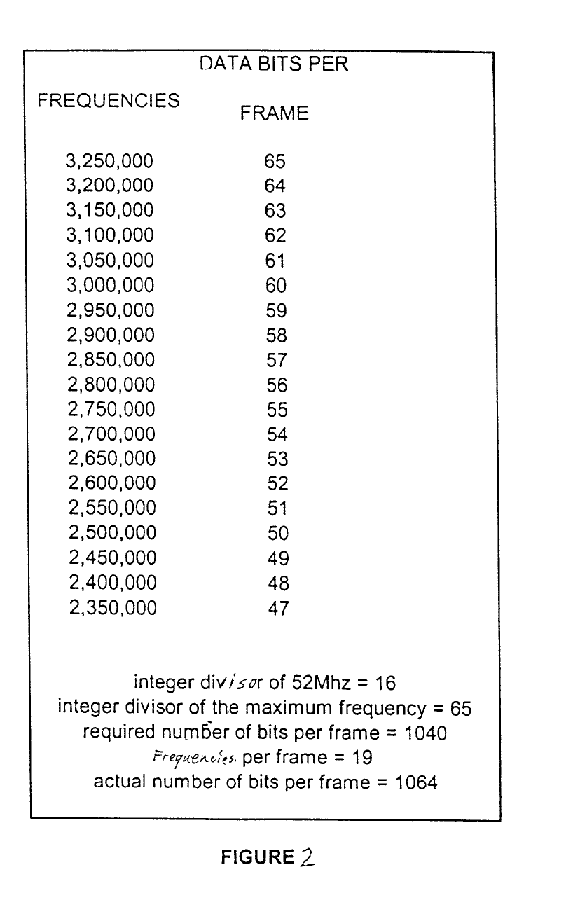

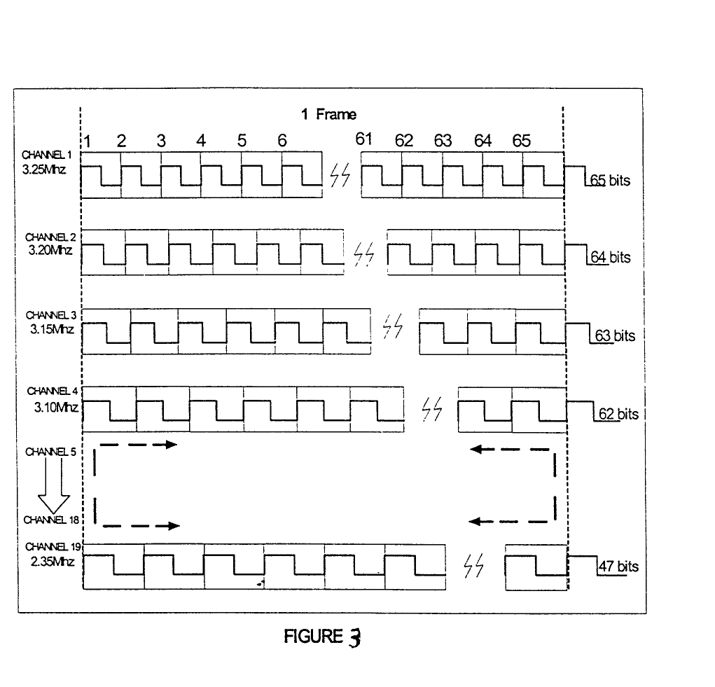

From the above, it will be appreciated that by increasing the frequency of the master clock to 4×52 MHz, the subsequent frequencies are kept sufficiently close together without having to resort to non-integer divisors, which would require separate clock generators. Nevertheless, it will be appreciated that a master clock with a different frequency than 208 MHz could be used. Different divisors could also be chosen. Preferably though, as described above, a maximum frequency of 3.25 MHz should be used when a total transfer rate of 52 Mbs is desired. Instead of deriving the lower frequencies by incrementing the divisor by 1 each time, a different incrementation could be used, including non-integer increments. Another embodiment derives the frequencies by dividing the desired throughput, e.g. 52 Mbs by increasing integer divisors. The invention could also be implemented using other techniques, such as having each lower frequency separated from the previous one by a fixed amount, e.g., 50 kHz, as shown in FIGS. 2 and 3. Furthermore, although the present embodiment discusses various unique frequencies each with a data rate corresponding to its frequency, it is possible to implement the invention so as to transmit more than one bit per cycle. Thus a 3.25 MHz signal could, for example, support a data rate of 6.5 MBs or 13 Mbs.

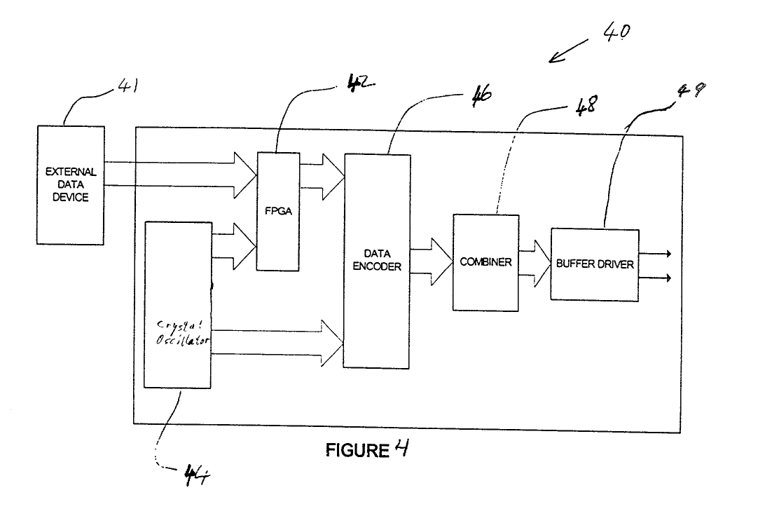

The present embodiment provides for a data transfer rate of 52 Mbs via a transmitter 40 as shown in FIG. 4. The present embodiment's transmitter 40 receives data from an external data device 41 which consists of a single stream of digital data for all the frequencies. The transmitter 40 consists of the following architectural blocks:

a Field Programmable Gate Array (FPGA) 42,

a crystal oscillator 44 of 52 MHz.

a data encoder 46 comprising 19 encoding devices for creating BPSK encoded signals,

a combiner 48 that will merge 19 data carrying frequencies and a clock reference or pilot frequency into a single complex, modulated signal,

a buffer/driver circuit 49 capable of transmitting the modulated signal over telephone cable.

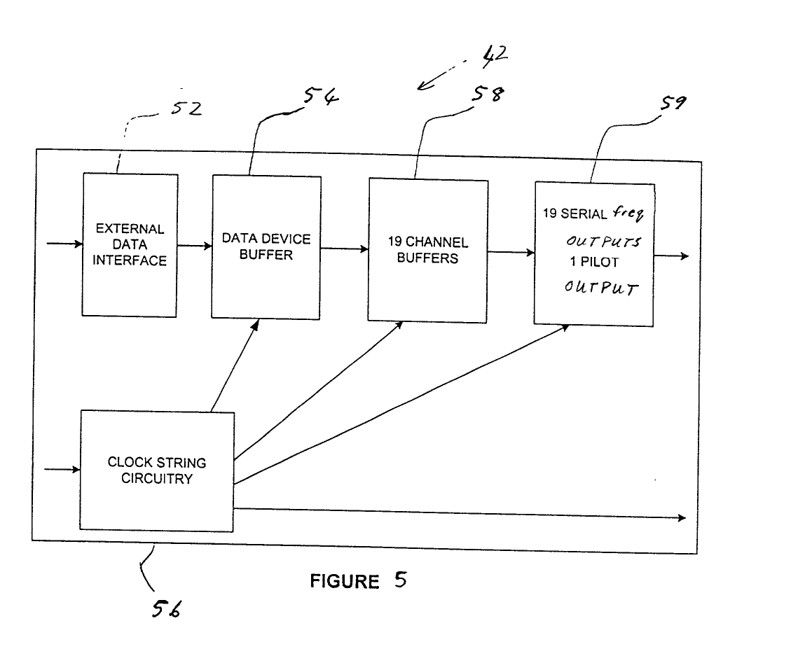

The present embodiment's transmitter implements the FPGA 42 with the following functional blocks as shown in FIG. 5

an external data device interface 52,

a buffer 54 capable of storing a minimum of two frames of data from the data device,

multiple frequency clock string circuitry 56 that produces 20 frequencies that are each 10 times faster than the frequency of a corresponding unique frequency used for base band modulation and are phase locked to these fundamental frequencies.

19 buffers 58 capable of storing one frame's amount of data,

19 serial frequency outputs and 1 serial clock reference output 59.

Frequencies that are 10 times larger than the fundamental frequencies are necessitated by the present encoder to enable BPSK encoding. Other embodiments, making use of other encoding schemes, e.g., QPSK could be adopted, requiring different frequency multipliers.

The FPGA 42 of the present embodiment's transmitter 40 utilizes an interface 52 to the external data device 41. The data device 41 is capable of producing serial data at transfer rates of 52 MBS, and is connected to an input pin of the FPGA 42. The FPGA 42 implements the buffer circuitry 54 that will store up to two frames of data from the data device, as a First In First Out (FIFO) device. By storing up to two frames of data, adequate buffering is provided such that a frame of data will be in the process of being transmitted while a succeeding frame of data will have been buffered to avoid propagation delay due to the numerous devices used to implement the present embodiment. It will be appreciated that the functionality of the FPGA could be implemented using discrete components, or other types of dedicated integrated circuits or other suitable techniques.

A frame is used to keep track of the transmission of bits from the FIFO so that no less than 52 Mbs of data is continuously transmitted. If data is read from the FIFO too fast, there will be underwriting to the buffer. Similarly, if the FIFO is read from too slowly, there will be overwriting, and therefore, loss of data. As discussed above, in this embodiment where the data transfer rate for each frequency corresponds to the frequency, the actual total data transmission rate is the sum of the clock rates for all frequencies, which in this embodiment is actually 54.445 Mbs. The frame is used by FPGA 42 to insure that each frequency is getting a sufficient number of bits to sustain continuous transmission of data. Since bits are read from the FIFO at the desired transmission rate (54.445 Mbs in this case), data has to be written to the FIFO at the same rate in order to sustain a continuous transmission rate of 54.445 Mbs. However, since the fastest frequency is transmitting at 3.25 Mbs, after 1/(3.25 MHz) the fastest frequency will have supplied only one bit, while the slower frequencies will still be in the process of supplying their first bit. Thus the throughput at startup without the benefit of a FIFO would be only 3.25 Mbs. Since a minimum of 16 bits must be transmitted in this time interval of 1/(3.25 MHz) in order to sustain the desired throughput, a larger frame size must be used. If we consider a time interval of 2/(3.25 MHz), we see that by the time the fastest frequency has transmitted its second bit, the other frequencies will have transmitted only one bit. Thus after 2/(3.25 MHz), only 20 bits will have been transmitted. This equates to 20 bits per 2/(3.25 MHz) or a throughput of 32.5 Mbs. Performing similar calculations for larger numbers of bits produces a frame interval based on 8 highest frequency bits. Calculations show that for this embodiment a total of 134.02 bits are transmitted during this time interval, which comfortably meets the 128 bit requirement to support the desired 52 Mbs throughput. Ideally, the minimum frame size is determined by dividing the desired transmission rate by the maximum transmitted frequency (frequency 1) and an integer number. In the present embodiment a frame of less than 8 bits would require more than 19 base band frequencies of data. Transmitting less than 8 bits of the highest frequency, or less than a total of 19 frequencies would result in less than a total of 128 bits being transmitted in a frame. Minimum frame size is dependent on the various frequencies, the separation between the frequencies, and the desired total transmission rate. Larger frame sizes could be implemented but would require larger buffers.

The non integer total of 134.02 bits is the result of the divider sequence implemented in FPGA 42 that creates the various transmission frequencies. An algorithm implemented in FPGA 42 keeps track of which frequencies have how many bits within each frame. However, it will be appreciated that the extra bits could be used for other purposes, e.g., to provide control information that does not reduce actual data transmission rate below 52 Mbs. As noted above, the FPGA 42 has a frame buffer capable of buffering no less than 270 bits of data received from the external data device 41 at any one time.

It will be appreciated that the frame size could, instead, be chosen to support ATM networks which are commonly found in large bandwidth data networks such as Internet backbones. For example, the lowest transmission rate in ATM networks, known in the field of fiber optics as OC1, is 51.84 Mbs. ATM data is contained in cells that consist of bytes which, in turn, each consists of 8 bits of data. The ATM network makes use of a 8 kHz master clock to synchronize end to end communication. Thus, in any given cycle, the 51.84 Mbs OC1 network will transmit 6480 bits. The present invention could be implemented to support these parameters using the same frequencies as the embodiment discussed above, and a FIFO capable of buffering 2×6480 bits. It will be appreciated that the GFM system of the present invention would also have to be synchronized to the master clock of the ATM network.

The present embodiment's transmitter 40 uses 20 frequencies. Nineteen of these transmitted frequencies are used for carrying data and the 20th frequency is defined as a pilot frequency. The pilot frequency implements two functions. First, it is used as a reference signal to enable the receiver to phase lock it's base band frequencies to associated transmitted base band frequencies. Second, it is used to indicate when the transmission of a frame has begun. Normally the pilot frequency is encoded with a single binary value, e.g., binary “1” data value. When the transmitter FPGA 42 begins the transfer of a frame, the pilot will have an opposite binary value repeated twice, in this case, binary “0” value, encoded into it, whereafter it will have only binary “1” encoded into it. In the present embodiment the pilot channel is chosen by dividing the 208 MHz master clock by 64 to arrive at the highest frequency signal, namely 3.25 MHz, and further dividing this by 16 to arrive at the pilot frequency of 203.125 kHz for reasons discussed in greater detail below. It will be appreciated that the pilot frequency can be arrived at by simply dividing the master clock by 1024, in one step. It will also be appreciated that, in another embodiment, a separate channel could be used to indicate when the transmission of a frame has begun.

The present embodiment's transmitter 40 implements 19 individual frequency buffers 58 in the FPGA 42. Each buffer 58 will store up to 1 frame's count. The FPGA 42 implements circuitry that counts the number of bits stored in the data device buffer 54 and when a minimum of 2 frames of data have been stored, the first frame of at least 135 data bits is transferred in parallel to the 19 frequency buffers 58.

Data from the data device is stored in the data buffer 54 such that the first bit stored for the defined frame count of 135 bits, is defined as the most significant bit of a frame. The bit that is stored that is the last bit of the frame count is defined as the least significant bit of the frame. Data is transferred from the data device buffer 54 to the frequency buffers 58 such that the most significant bit is transferred as the most significant bit of the buffer 58 of the maximum frequency. The least significant bit of the frame is transferred as the least significant bit of the buffer 58 of the 19th frequency, or lowest frequency.

When a frame's amount of data has been transferred to the frequency buffers 58, the FPGA circuitry 42 starts to simultaneously transfer one bit at a time from all frequency buffers 58 to the 20 encoding devices of the encoder 46. In the present embodiment the encoding devices take the form of balanced modulators. These devices 46 are external to the FPGA 42. The FPGA 42 provides each of these encoding devices with a data bit from a corresponding frequency buffer 58 and also provides a frequency clock for each frequency from the clock string circuitry 56. Each frequency clock is identical to the specified frequency of the transmitted frequency. The balanced modulator performs D/A conversion on the data by producing for each frequency, a sinusoidal wave shape that has a zero crossing, or 180° phase shift, associated with a logic change in the binary data. The pilot frequency and its corresponding frequency clock will also be connected to a balanced modulator so that a pilot sinusoidal wave shape is created.

An encoded binary “1” is created by a balanced modulator when the positive going zero crossing of a specific frequency's clock is coincident with the rising edge of a digital binary “1”. If the digital data is a binary “0” during the positive going zero crossing of the clock, the balanced modulator will create an output that is 180° phase shifted with respect to an encoded binary “1”. The balanced modulator is capable of changing the output phase on a cycle per cycle basis for all 19 data frequencies and the pilot frequency.

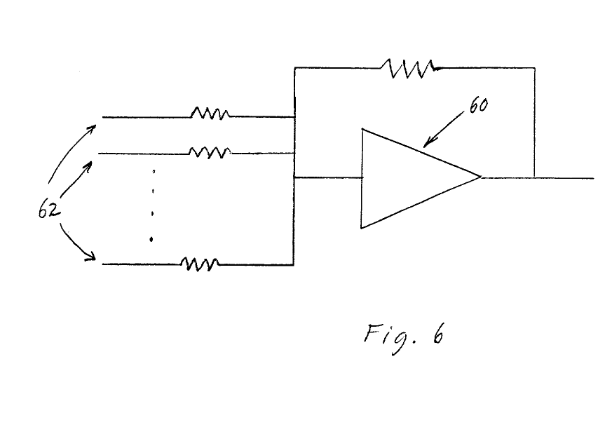

The 19 base band encoded frequencies and the pilot frequency are combined in combiner 48 to create the broadband signal, which is a complex, modulated signal. The combiner 48 can be implemented in any one of a number of ways to combine the various frequencies into a single complex, multiple frequency signal. The present embodiment utilizes an implementation referred to as a summation amplifier 60 as shown in FIG. 6. The 19 encoded frequency inputs and the pilot frequency 62 are fed into the summation amplifier 60. The output of the summation amplifier 60 is connected to the buffer/driver circuit 49 shown in FIG. 4, which is capable of driving the wire of a telephone cable.

As each base band encoded frequency changes phase in response to the digital data, sidebands are produced. For example, the highest transmitted frequency (frequency 1) which has a base frequency of 3.25 Mhz, will produce only a 1.625 MHz sideband if a continuous digital sequence such as 010101 is transmitted because the resultant signal is essentially a waveform with half the duty cycle. In the same way, a pattern of 11001100 is a signal with one-fourth the duty cycle.

The present invention describes a means of decoding these base band encoded frequencies even in the case of digital data patterns that have similar sidebands such as 0101 (55 hex pattern) and 1010 (AA hex pattern) or between 11001100 (CC pattern) and 00110011 (33 hex pattern). Each frequency has a unique set of sidebands that are separate and distinguishable from all other frequencies. The present embodiment transmits each of the unique fundamental frequencies and up to 14 sidebands for each of the unique frequencies. In a preferred embodiment, only the lower sidebands with respect to the fundamental frequency are transmitted. Further, the present invention describes a method whereby four of the transmitted sidebands of each fundamental frequency provide sufficient information to recover encoded data. It will be appreciated that all of the sidebands could be used if desired. Further, the present invention contemplates the use of the fundamental signal as a means to recover transmitted information, depending on the extent of the attenuation and dispersion that result from the type and length of wire utilized.

By using four side bands, not only the existence of a phase change, but also the nature of the phase can be determined. In the case of a 3.25 MHz fundamental frequency, good results are obtained using the half frequency of sideband 1.625 MHz and three other sidebands. It will be appreciated that the lower frequencies, such as the second frequency of 3.20 MHz, will produce their own sets of sidebands that can be decoded.

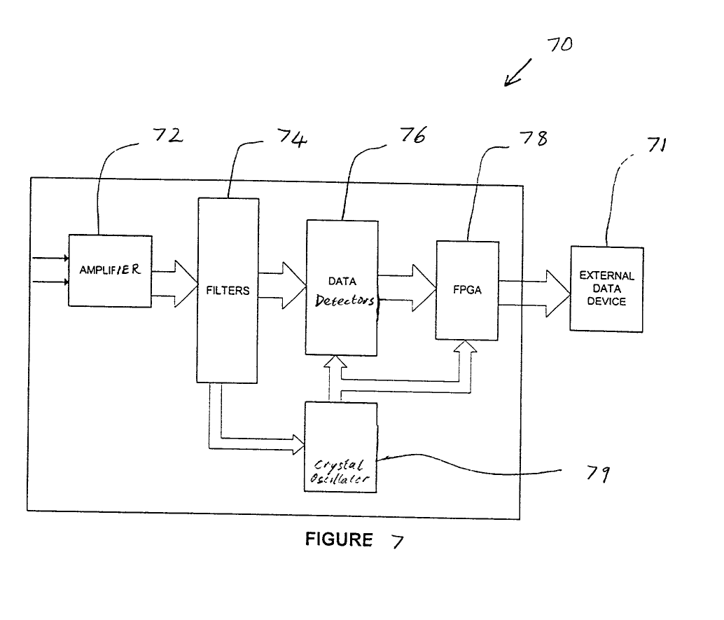

As shown in FIG. 7, the present embodiment provides for a receiver 70 that will recover data as generally described previously, and transfer data at a rate of 52 MBS to an external device 71. The present embodiment's receiver 70 consists of the following architectural blocks:

an amplifier 72 for receiving a complex, multiple frequency signal that may have been reduced in amplitude by as much as 100 dB.

76 band pass notch filters 74, each of which will block all other frequencies except for a sideband frequency associated with a particular one of the 19 data carrying frequencies. In addition, the receiver includes 1 band pass notch filter 84 that will block all other frequencies except the single pilot frequency,

20 bipolar detectors 76,

a FPGA 78,

a phase locked loop circuit to create a recovered master clock 79.

The FPGA 78 is shown in greater detail m FIG. 8. It has the following functional blocks:

40 inputs 80 (20 plus and 20 minus inputs) from detectors 76.

19 frequency buffers 82 capable of storing up to 1 frame's amount of data

a buffer 84 capable of storing a minimum of 2 frames worth of data from the 19 frequency buffers 82.

an interface to an external data device 88.

The present embodiment's receiver 70 is connected to the wire of a telephone cable by means of the amplifier 72 that will recover the transmitted GFM waveform. The amplifier 72 is implemented by someone skilled in the art such that it is capable of recovering the GFM waveform in spite of an amplitude loss of as much as 100 dB. Signals with a loss of more than 100 dB may be usable depending on the transmission media itself. Typical telephone wire connections contain broad spectrum noise whose amplitude typically averages −110 to −105 dB or 5 dB smaller than the smallest usable signal described by the current embodiment.

The output of the amplifier 72 is connected to another buffer amplifier (not shown) whose output drives the inputs of the band pass notch filters 74. Each of these filters 74 will be tuned to block all frequencies except for a specific sideband associated with each data carrying frequency. Each data carrying frequency requires a filter for 4 specific sidebands in order to successfully decode a frequency's encoded data. The filters 74 can be implemented in any one of a number of known ways including the use of tuned resonant circuits that use devices such as inductors, crystals, or resonators. Filters may also be implemented by using DSP technology or other know processor based filter implementations.

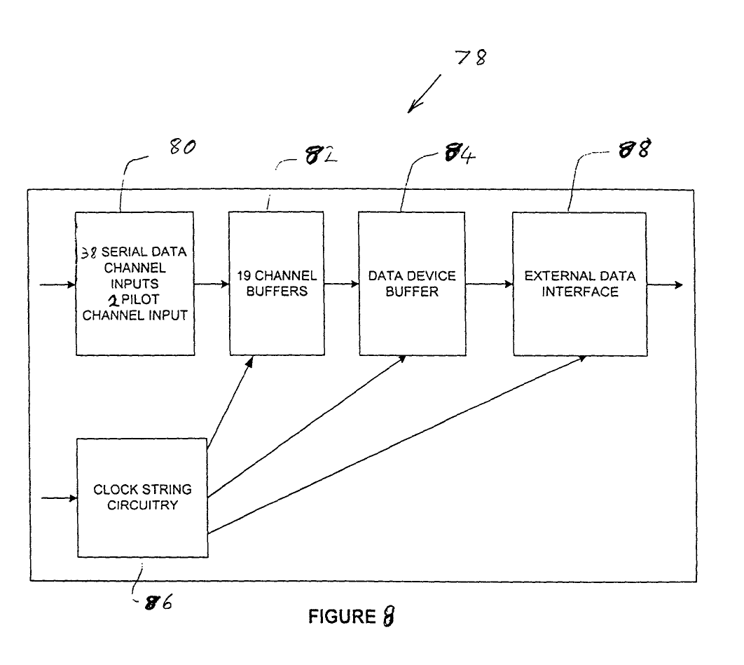

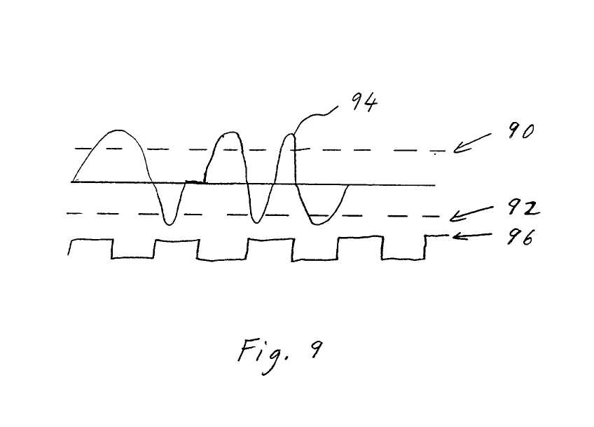

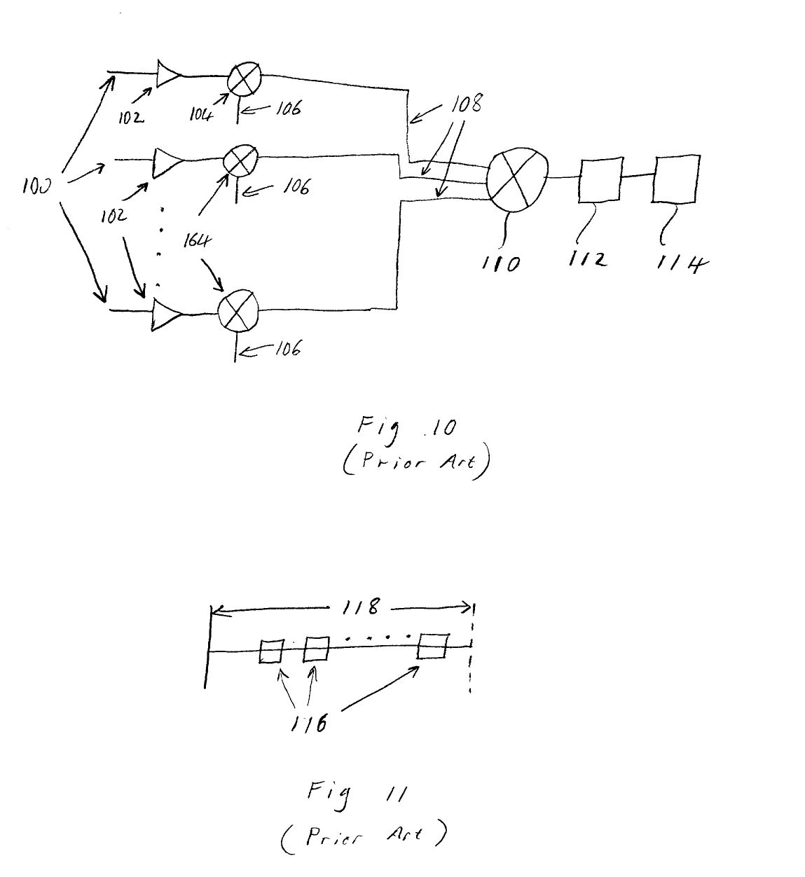

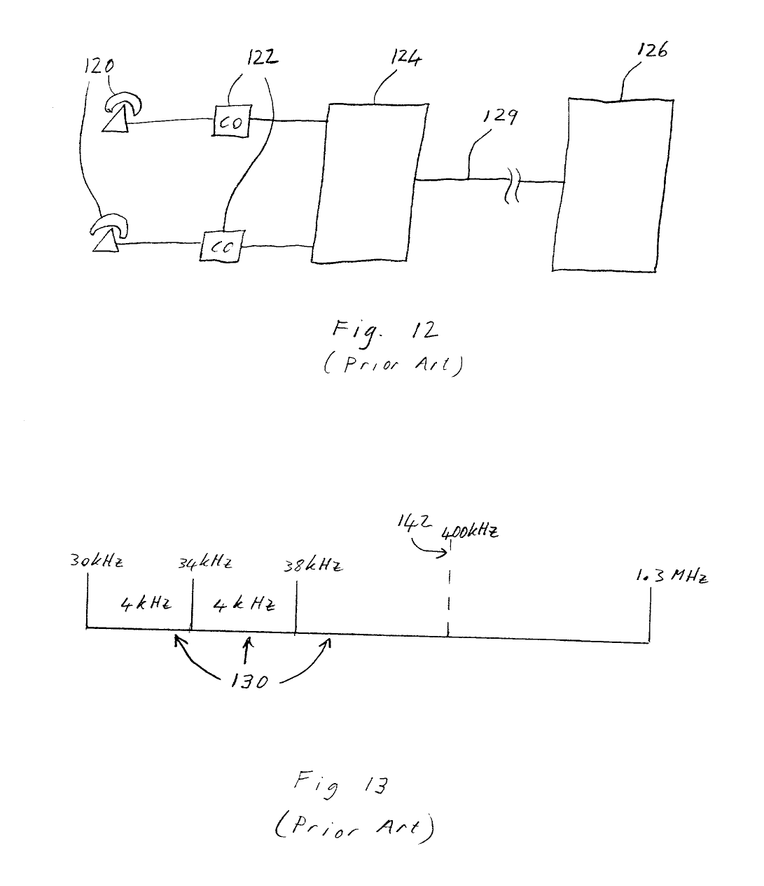

The filters, in effect, provide frequency windows. For example, for the 3.25 MHz signal, a 1.625 MHz sideband filter will produce a sine wave at 1.625 MHz if such a sideband is detected, and only for the duration that the sideband is being transmitted. Thus, each filter produces a sine wave signal at the frequency to which it is tuned. In the case of BPSK, by looking at a minimum of four consecutive sidebands, a 180 degree snap shot of a frequency is obtained which gives both frequency and phase information. Thus, although the different side bands will be produced at different times, by summing the various outputs of the four sidebands using a summation amplifier, a waveform is produced that potentially changes the phase by as much as 180 degrees from the previous cycles phase. as shown in FIG. 9.

The output of the frequency filter 74 that is tuned to the frequency of the pilot frequency produces a sinusoid that is amplified separately from all other signals. The output of this amplifier is used as a reference that enables the receiver's clock string circuitry 86 to phase lock to the transmitter's clock string circuitry 56. The output of the receiver's phase locked recovered master clock provides a means whereby clock recovery is not dependent on transmitted data. In the present embodiment, the pilot frequency is chosen as 203.125 kHz, as discussed above. By providing a slow pilot frequency, a very robust reference is provided which has a roll-off of only approximately 30 dB. It will be appreciated that other frequencies could be used for the pilot channel provided the frequency is relatively low to avoid excessive loss of signal. Furthermore, from a practical perspective, the frequency cannot be too low for fear of interfering with other existing signals such as existing analog and basic rate ISDN. It also has to take into account the various sideband frequencies of the complex, modulated signal. For example, in this embodiment, the lowest fundamental frequency produces a lowest sideband frequency of 317 kHz. Thus, in this embodiment, the pilot frequency should be kept below this value to avoid interference with the sideband.

The present embodiment implements 20 bipolar detectors 76 capable of decoding BPSK encoded signals as recovered by filters 74. The output of each summation amplifier is connected to a detector 76. Each detector 76 determines both positive levels 90 and negative levels 92 (FIG. 9), which are used by the FPGA 78 to extract digital information.

The outputs of the detectors 76 are connected to input pins of the receiver's FPGA 78. The detector 76 that is connected to the pilot frequency filter is connected to the recovered master clock phase lock and to an input pin of the receiver's FPGA 78 such that this pin will be used to decode when the start of a frame has occurred.

The present embodiment's receiver FPGA 78 implements 19 identical state machine circuits that determine if the detector 76 has detected a binary “1” or a binary “0”. FIG. 9 shows a signal 94 for one of the frequencies, comprising 4 summed filter outputs, and a frequency corresponding to the clock frequency 156. By looking at a 180 degree portion of the spectrum, it has been found that:

A positive excursion exceeding the positive voltage level 90 corresponds to digital 1,

A negative excursion exceeding the negative voltage level 92 corresponds to digital 0,

Two opposite excursions within one 180 degree window of interest corresponds to a digital 1 if the negative excursion precedes the positive excursion, and corresponds to a digital 0 if a positive excursion proceeds the negative excursion.

If no excursion is detected within the 180 degree window the data for this cycle corresponds to the previous determined data bit. It is possible for a number of cycles to occur where there is no valid excursion. If this occurs the data for each cycle remains the same value as determined by the last valid excursion.

Receiver FPGA 78 stores the result of each state machine determination on a cycle per cycle basis at the transmission rate for each frequency. The results are stored in the 19 frequency buffers 82 that are identical in size and design as the 19 frequency buffers 58 of the transmitter 40. The FPGA circuitry 78 counts the number of bits that are stored in these 19 buffers 58 and when a full frame of 134 data bits is stored in the 19 buffers, all buffers 82 have their information transferred to a data device buffer 84.

The present embodiment's receiver FPGA 78 implements the data device buffer 84 identical in size and design as the data device buffer 54 of the transmitter 40. The FPGA circuitry 78 will begin to transfer data from the data device buffer 84 one bit at a time to the external data device interface 88 when a minimum of 2 frames of data have been received. Data is transferred to the external device in the same serial order, as it was stored in the data device buffer 54 of the transmitter 40.

While specific embodiments have been described above, it will be appreciated that the invention can be implemented in different ways without departing from the scope of the invention.

What is claimed:

1. A method of sending information over metal wire comprising
encoding binary information onto each of a plurality of predefined frequencies using a base band process, and
combining the frequencies into a single complex signal.

2. A method of claim 1, wherein the encoding of each frequency involves BPSK.

3. A method of sending information over metal wire comprising
combining a plurality of predefined frequencies, wherein each frequency is base band encoded with binary data to carry a different amount of information in a given period of time.

4. A method of claim 3, wherein a highest frequency is chosen by determining a practical
maximum frequency for a desired distance; selecting a desired information throughput, and
dividing the desired throughput by an integer divisor that will provide a highest frequency not exceeding the maximum frequency.

5. A method of claim 4, wherein subsequent lower frequencies are the result of dividing the desired throughput or a multiple thereof by ever increasing higher integer or non-integer divisors or by subtracting a predetermined frequency value from each preceding frequency to arrive at the next lower frequency.

6. A method of claim 5, wherein the base band encoded frequencies are combined by means of at least one summation amplifier.

7. A method of claim 6, wherein each base band encoded frequency is decoded by analyzing the power inherent in each base band signal.

8. A method of claim 6, wherein each base band encoded frequency is decoded by analyzing a plurality of its sidebands.

9. A method of claim 8, wherein one of the sidebands is the sideband having half the frequency of the base band frequency being analyzed.

10. A method of claim 9, wherein the number of sidebands considered provide frequency variation information across 180° of the spectrum.

11. A method of claim 10, wherein the sidebands are considered for positive and negative excursions of the signal, and wherein:
a positive excursion exceeding a pre-determined positive threshold corresponds to a digital one;
a negative excursion exceeding a predetermined negative threshold corresponds to a digital zero; and,
two opposite excursions within a 180° portion of the spectrum define a digital one if the negative excursion precedes the positive excursion and define a digital zero if the positive excursion precedes the negative excursion.

12. A transmitter for sending information over metal wire comprising
a multiple frequency clock source;
a data encoder for creating a plurality of BPSK encoded data-carrying baseband signals; and,
a combiner for merging the signals, wherein the clock source produces a different frequency clock signal for each of a plurality of data-carrying baseband signals and for a pilot signal.

13. A transmitter of claim 12, further comprising a buffer capable of storing at least two frames of data, wherein a frame is an integer divisor of the highest frequency multiplied by the period of a cycle of said highest frequency.

14. A receiver for decoding a multiple frequency signal comprised of a plurality of predetermined data carrying frequencies that are each base band encoded using BPSK techniques, comprising
a set of filters tuned to the frequencies of a plurality of sidebands for each of the data carrying frequencies, and means for analyzing the plurality of sidebands of each data carrying frequency to decode the data.

15. A receiver of claim 14, further comprising a data buffer capable of storing at least two frames of incoming data, wherein a frame of incoming data is defined as an integer divisor of the highest frequency multiplied by the period of a cycle of said highest frequency.

16. A receiver of claim 14, wherein the plurality of sidebands cover 180° of phase.

17. A receiver of claim 14, wherein, for each data carrying frequency, one of the filters for the sideband signals is tuned to the sideband having half the frequency of the data carrying signal.

18. A method of sending information over metal wire comprising
encoding binary information onto at least one predefined frequency using a base band process;
defining a frame for the information, and
combining the at least one frequency with a pilot frequency to achieve end to end synchonization.

19. A method of claim 18, wherein the pilot frequency is encoded with information to identify the beginning of each frame.
